(19) United States
(12) Patent Application Publication
(10) Pub. No.: US 2009/0319530 A1
(43) Pub. Date: Dec. 24, 2009

(54) MECHANISM FOR UNEQUIVOCALLY REFERENCING CONTENT IN WEB 2.0 APPLICATIONS

(75) Inventors: Christian Hoertnagl, Kilchberg (CH); James F. Riordan, Rueschlikon (CH); Daniela Bourges-Waldegg, Rueschlikon (CH)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/141,255

(22) Filed: Jun. 18, 2008

(51) Int. Cl. G06F 17/30

(52) U.S. Cl. 707/10; 707/E17.032

(57) ABSTRACT

A method is provided for referencing content by generating a bound uniform resource locator. Content is selected, a fragment identifier is calculated for the content, and the content is normalized. A content digest of the normalized content is calculated. A content binding document is assembled in which the content binding document comprises: an original URL to the content, the fragment identifier, the name of a method for normalizing the content, the name of a method for calculating the content digest, and the content digest. A content binding document digest is calculated. A bound universal resource locator is generated that contains the content binding document digest and the name of the method that was used to calculate the content binding document digest. The content binding document is stored using its digest as a file name or database key, and the content binding document can be retrieved using the bound universal resource locator.

### CROSS-REFERENCE TO RELATED APPLICATIONS

This application contains subject matter which is related to the subject matter of the following co-pending applications, each of which is assigned to the same assignee as this application, International Business Machines Corporation of Armonk, N.Y. and each of the below listed applications is hereby incorporated herein by reference in its entirety: Attorney Docket Number CH920070112US1, filed Jun. 18, 2008.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### FIELD OF INVENTION

Exemplary embodiments of the invention relate to referencing content via a network.

### DESCRIPTION OF BACKGROUND

Web 2.0 content is very dynamic, due to the nature of the applications producing it and the very large number of eligible content authors (potentially everybody with access to a web browser): collaborative and open editing (wikis), frequently changing personal or collective journals (blogs), on-the-fly combinations of content from different sources (mashups), etc.

Many Web 2.0 applications rely on such dynamic content to provide some other service. For example, annotation applications (e.g., diigo, fleckit, google notebook) allow users to visit any web page, highlight portions of it, and place personal annotations that are later retrieved when the page is viewed again. This class of applications depends on specific versions of the content, as an annotation made on one version may not apply to a later version (e.g., the portion the annotation is attached to changed). Since the content is dynamic, a common approach is to copy and store the web page (or portion of webpage) into a server at the moment of the annotation. However, this is not always desirable as it can incur liability costs (e.g., copyright violations) or even result in confidentiality breaches as intranet content may be copied to an external server. It also places unnecessary burdens on the infrastructure (e.g., for storing redundant copies).

It is also necessary to reference specific versions of content when web resources such as Wikipedia articles or blog entries are cited or linked to in a different context (for example, a Wikipedia article cited in a newspaper article). Permalinks are the most widely used mechanism in this context. A permalink is a reference generated by the server where the content is hosted. The server uses this reference as a database key or as a query to retrieve a specific portion or version of content. Permalinks are not portable (there exist many implementations of permalinks, which are site-specific) and moreover, the binding between the content and the reference is not strong for a permalink. In other words, one needs to trust the server to return the right content for a given permalink. Furthermore, permalinks only refer to whatever version of content is currently associated with a given name; there is no intrinsic mechanism to ensure that the reference is to an unmodifiable specific version or fragment of content. (E.g., in the case when references to legal documents are made, this may have severe repercussions, for even modifications to only a few isolated words can affect the overall meaning of binding sentences and paragraphs.) Another existing mechanism is the Digital Object Identifier, which uses a central authority to establish and resolve the binding between content and name.

For applications that require assurance about the binding between the reference and the content (e.g., for applying digital signatures), none of these mechanisms is appropriate. It would be beneficial to have mechanisms for ensuring a strong binding between references and content, such that if the content is modified, the reference becomes invalid.

### SUMMARY

In accordance with exemplary embodiments, a method is provided for referencing content by generating a bound uniform resource locator. Content accessible via a standard URL is selected, a fragment identifier is calculated for the content, and the content is normalized. A content digest of the normalized content is calculated. A content binding document is assembled in which the content binding document comprises: the original URL from which the content was retrieved, the fragment identifier, the name of the method for normalizing the content, the name of the method for calculating the content digest, and the content digest. A content binding document digest is calculated using a (possibly different) digest method. A bound universal resource locator is generated that contains the content binding document digest and the name of the method used for calculating the content binding document digest. The content binding document is stored using its digest as a file name or database key, and the content binding document can be retrieved using the bound universal resource locator.

In accordance with exemplary embodiments, a method is provided for verifying content that has been referenced by a bound uniform resource locator. A bound uniform resource locator is parsed to obtain a content binding document digest and to obtain the name of the method that was used for calculating the content binding document digest. A content binding document is retrieved using the bound uniform resource locator. A computed content binding document digest is calculated using the method for calculating the content binding document digest obtained from the bound uniform resource locator. The computed content binding document digest is compared to the content binding document digest. In response to the computed content binding document digest being the same as the content binding document digest, the content binding document is parsed to obtain individual elements. The content binding document includes an original URL to a content, a fragment identifier, the name of a method for normalizing the content, the name of a method for calculating a content digest, and the content digest. The content is retrieved using the original URL to the content and the fragment identifier. The content is normalized using the method for normalizing the content obtained from the content binding document. A computed content digest is calculated using the method for calculating the content digest obtained from the content binding document. The computed content digest is compared to the content digest. In response to the computed content digest being the same as the content digest, the bound uniform resource locator is validated.

System and computer program products corresponding to the above-summarized methods are also described and claimed herein.

Additional features are realized through the techniques of the present invention. Other embodiments and features of the invention are described in detail herein and are considered a part of the claimed invention. For a better understanding of features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features of the invention are apparent from the following detailed description taken in conjunction with the accompanying drawings in which:

FIG. 1 illustrates a process for generating a bound uniform resource locator in accordance with exemplary embodiments;

FIG. 2 illustrates a process for verification of a bound uniform resource locator in accordance with exemplary embodiments;

FIG. 3 illustrates an example of a system in accordance with exemplary embodiments; and

FIG. 4 illustrates an example of a computer having capabilities, which may be included in exemplary embodiments.

The detailed description explains exemplary embodiments of the invention, together with advantages and features, by way of example with reference to the drawings.

### DETAILED DESCRIPTION OF EXEMPLARY EMBODIMENTS

Exemplary embodiments provide a mechanism for unequivocally referencing content accessible via, e.g., a URL (using, e.g., HTML/XML content), without the need for storing the content; without the need for a central authority; with the ability to subselect content; with the ability to link old and new versions of the content; and with the ability to normalize content for security and long-term stability. Exemplary embodiments provide a mechanism that produces bound URLs, which are themselves URLs and thus can be readily used in the context of the Web. Exemplary embodiments provide a mechanism, which allows reference to content at a fine granularity and addresses also references made within the referenced content.

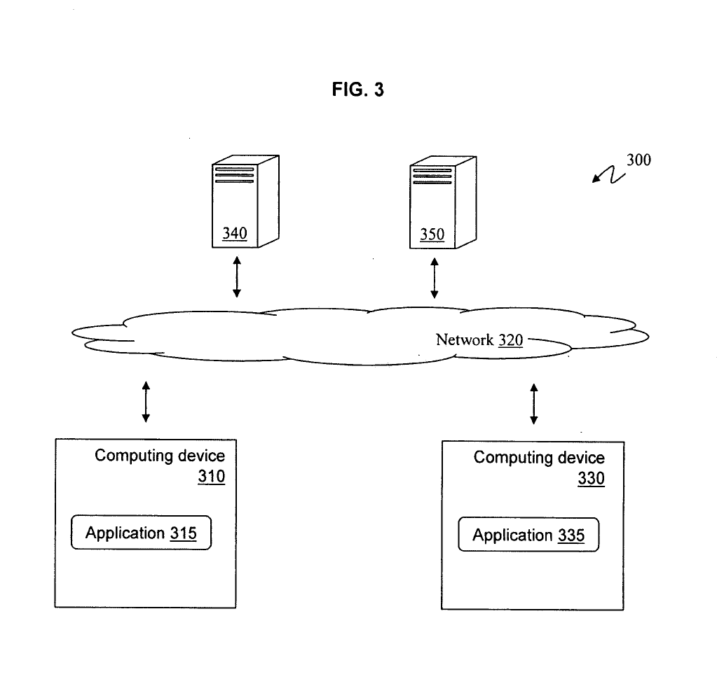

FIG. 3 illustrates a system 300 in accordance with exemplary embodiments. The system 300 may include a computing device 310 and a computing device 330. It is understood that in exemplary embodiments and implementations, the computing devices 310 and 330 can be a variety of communications devices, such as general purpose computers, laptop computers, cellular telephones, personal digital assistants (PDA), digital music players (e.g., MP3 players), mobile devices, digital televisions, etc. The computing devices 310 and 330 may communicate with each other, a server 340, a server 350, or any other entity via a network 320.

The network 320 may include circuit-switched and/or packet-switched technologies and devices, such as routers, switches, hubs, gateways, etc., for facilitating communications among the computing device 310, the computing device 330, the server 340, the server 350, and any other network entity. The network 320 may include wireline and/or wireless components utilizing, e.g., IEEE 802.11 standards for providing over-the-air transmissions of communications. Also, the network 320 may include wireline and/or wireless components utilizing standards for, e.g., multimedia messaging services (MMS). According to exemplary embodiments, the network 320 can facilitate transmission of content, which may include any type of media (e.g., images, video, data, etc.). The network 320 can also be a local area network, a wide area network, a metropolitan area network, an Internet network, or other similar types of networks. The network 320 may be a cellular communications network, a fixed wireless network, a wireless local area network (LAN), a wireless wide area network (WAN), a personal area network (PAN), a virtual private network (VPN), an intranet or any other suitable network, and the network 320 may each include equipment for receiving and transmitting signals, such as a cell tower, a mobile switching center, a base station, and a wireless access point.

The computing devices 310 and 330 may respectively include applications 315 and 335 that can implement exemplary embodiments as discussed herein. The applications 315 and 335 may have the same and/or similar functionality in accordance with exemplary embodiments.

Applications 315 and 335 may be used to create and verify bound references in exemplary embodiments. In accordance with exemplary embodiments, a bound reference may be defined as a unique identifier, whereby the unique identifier itself contains a digest of the content it identifies as well as the necessary information to perform the verification of this binding and information as to how to retrieve the content, may be produced and consumed in a decentralized fashion, and comprises an extensibility mechanism whereby additional information can be easily included in the bound reference. A bound URL (or BURL) is a bound reference.

In a non-limiting example of a BURL, a double de-referencing mechanism may be used in which a BURL contains a digest of a content binding document (CBD) that can be retrieved using the BURL according to exemplary embodiments. The content binding document, in turn, contains the digest of the actual referenced content, together with a fragment identifier (such as an XPointer expression, for fine granularity references), and the content binding document contains information about the location of the content. The content binding document also contains the digest method and the normalization method which were used for the content.

As a non-limiting example, the following BURL is provided:

https://veracite.zurich.ibm.com/burls/d5351 . . . 51ab66?digest-method=md5

The preceding BURL serves (refers to) a content binding document whose digest is d5351 . . . 51ab66. The digest of the content binding document was calculated using the digest method indicated in the BURL. This content binding document contains the following information:

```
<burl>
  <permalink>
http://en.wikipedia.org/w/index.php?title=Currying&amp;oldid=
118180680
  </permalink>
  <logical-link>http://en.wikipedia.org/wiki/Currying</logical-link>
  <fragment-identifier>Scheme</fragment-identifier>
  <content-digest-method>md5</content-digestmethod>
  <content-digest>68b329da9893e34099c7d8ad5cb9c940</digest>
<content-normalization-method>https://veracite.zurich.ibm.com/
normalization/simplehtml_1.0</normalization>
  </burl>
```

In the content binding document above, the <permalink> is the permanent link giving access to the specific version of the content (when available). The permanent link may refer to a URL hosted on, e.g., the server 340.

The <logical-link> is the URL under which the content is normally accessed by users (when available). A logical link may be resolved to a permalink, such as in Wikipedia. The difference between permalink and logical link is that the permalink references explicitly a specific version of the content within the system where it was created, whereas the logical link provides a shorthand notation for users such that the decision as to what content to serve is left to the server (e.g., return the latest version). In the above example, the permalink points to version 118180680 of article “Currying” in Wikipedia, while the logical link simply points to the article “Currying” (and Wikipedia resolves this to the latest version of said article); the logical link, in this example can be viewed as referencing the concept “Currying”. When both a permalink and a logical link exist, it is necessary to include both in the content binding document, in order to establish their correspondence: a user may be referring to the content by its logical link, whereas the BURL applies to a specific version of the content, i.e., the permalink.

The <fragment-identifier> is a pointer into a specific portion of the document retrieved from the permalink URL. For example, the fragment-identifier may be an XPointer expression. An XPointer is a system for addressing components of XML based Internet media. An XPointer may be divided among four specifications: a “framework” which forms the basis for identifying XML fragments, a positional element addressing scheme, a scheme for namespaces, and a scheme for XPath-based addressing. The XPointer language is designed to address structural aspects of XML, including text content and other information objects created as a result of parsing the document. Thus, it could be used to point to a section of a document highlighted by a user through a mouse drag action.

The <content-digest> is the digest of the content retrieved from the URL indicated in the <permalink> element plus the fragment identifier. In other words, the <content-digest> is the digest of a portion of the document. This (content) digest was calculated using the method indicated in <content-digest-method>.

The <content-normalization-method> is the method used to normalize the content before digesting.

Note that in an implementation of exemplary embodiments, the BURL may rely on a server (such as the server 350) to store the content binding document. However, this server (e.g., the server 350) does not need to be trusted, as any modifications of the content binding document would cause the BURL verification to fail. Furthermore, a BURL can also be realized by in-lining the information contained in the content binding document as part of the URL's query string parameters.

Now, regarding content normalization, the content may need to be normalized (e.g., using an existing technique) prior to the calculation of the digest, so as to ensure that the input to the digest algorithm is the same in the generation of the BURL and in the verification of the BURL and, optionally, to prevent attacks in which content displays differently in different locations (via scripting, inclusion of externals, etc.). The normalization method depends on the content itself. For HTML, a normalization method may be used where certain elements are eliminated (such as scripts). HTML normalization also inlines a digest of referenced images into the content, to ensure that if a referenced image changes, the BURL does not validate anymore. As a non-limiting example,

### <img src=“http:// . . . ”>

becomes

### <img src=“http:// . . . ” veracite: digest=“ . . . ”/>

while the <script> . . . </script> elements would be removed entirely.

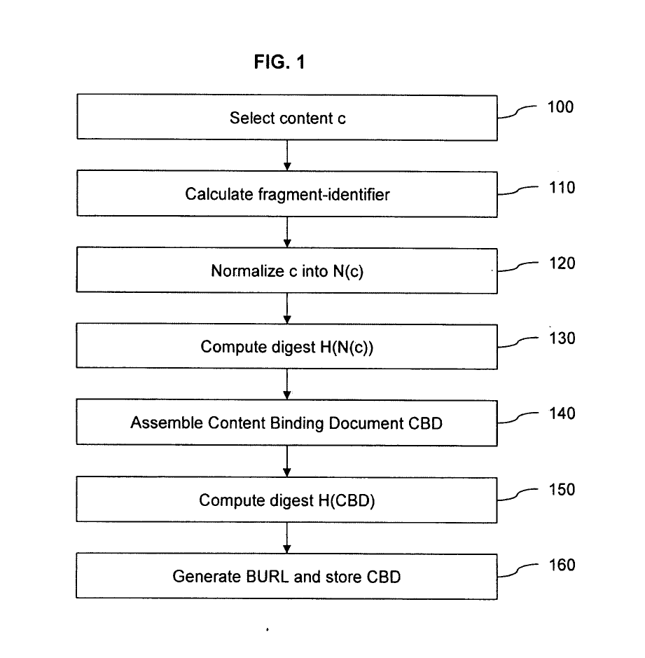

Now turning to FIG. 1, FIG. 1 illustrates a process for generating a bound uniform (or universal) resource locator (BURL) in accordance with exemplary embodiments. As a non-limiting example, the bound reference (e.g., the BURL) may be created on the computing device 310 via the application 315.

Content ‘c’ may be selected at 100. As a non-limiting example, a URL (link) may be used to access content from a web page hosted on the server 340, and the content (or a portion) may be selected (highlighted) from the web page hosted on the server 340.

A fragment-identifier is calculated for the content c at 110. As a non-limiting example, a fragment-identifier may be calculated based on the content c selected from the web page on the server 340. An Xpointer may be used to express the fragment-identifier.

The content c is normalized (into N(c)) at 120. The content c may be normalized to remove, e.g., scripting and inclusion of externals. The name of the method for normalizing the content is stored to be used again.

A digest of the content is computed, and the digest is the result from the computation of H(N(c)) at 130. The content digest is a hash function of the normalized content c. The hash function may be, e.g., a cryptographic hash function, which is a transformation that takes an input and returns a fixed-size string called the hash value, and whose main property is that it is nearly impossible to find two different inputs for which the hash value is the same (collision). The name of the method for calculating the content digest is stored to be used again.

A content binding document (CBD) is assembled at 140. The content binding document may be, e.g., a normalized XML document. The content binding document may be assembled to include a permalink/logical-link, the fragment-identifier, the content-digest-method, the content-digest, and the content-normalization-method. The permalink/logical link may be a URL to the content c hosted on the server 340. The URL is the URL from which the content c was retrieved. The content-normalization method was used to normalize the content c, which ensures a uniform format. The content-digest-method (e.g., hash function) was used to compute the content-digest.

A digest ‘d’ of the content binding document (CBD) is calculated by computing H(CBD) at 150. That is, a hash of the content binding document (which is an assembly of various items) is performed, resulting in a content binding document digest. The name of the method for calculating the content binding document digest is stored to be used again.

A bound URL (BURL) is generated and the CBD is stored at 160. The content binding document may be stored using its digest as a file name or database key. The BURL contains the digest H(CBD) of the content binding document and the location of the content binding document (CBD), as well as the name of the content binding document digest method. The BURL may indicate that the content binding document is located, e.g., on the server 350. The CBD can be retrieved from the server 350 using the BURL.

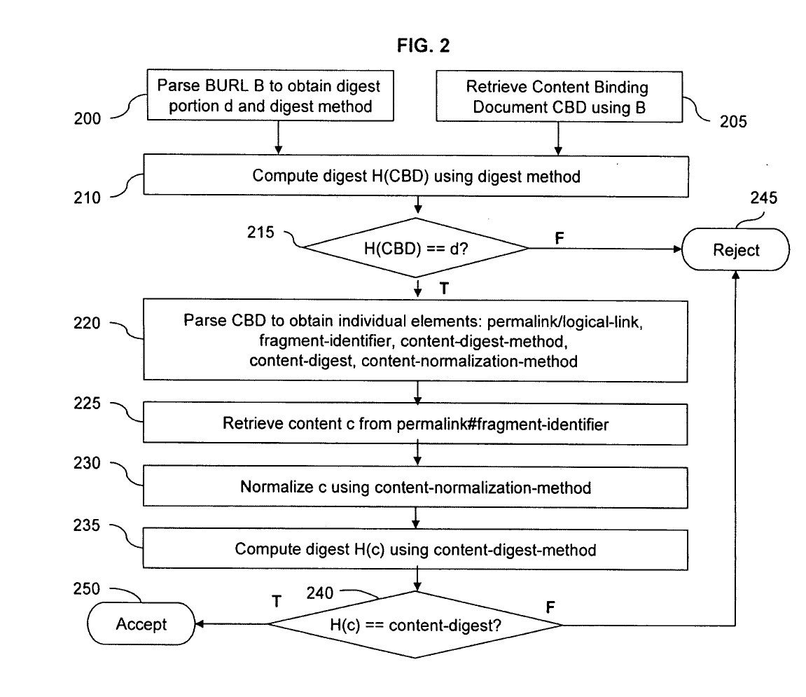

FIG. 2 illustrates a process for verification of a bound URL (BURL) in accordance with exemplary embodiments. The verification process occurs after the creation of the BURL, e.g., in FIG. 1. As a non-limiting example, the bound reference (e.g., the BURL) may be verified on the computing device 330 via the application 335.

The BURL may be parsed to obtain the content binding document digest portion d and the digest method at 200. In particular, parsing the BURL obtains the content binding document digest (the digest portion d) and the method for calculating the content binding document digest.

The content binding document (CBD) may be retrieved using the BURL at 205. The CBD may be retrieved from, e.g., the server 350.

A digest H(CBD) of the content binding document is computed using the digest method at 210. During the verification process, the computed content binding document digest is calculated using the digest method retrieved in operation 200.

A check is performed to determine whether the digest of the CBD computed during the verification process (the computed content binding document digest) is the same as the digest of the CBD calculated during the BURL creation process (and obtained in operation 200) at 215. If it is determined that the digest of the CBD (computed content binding document digest) calculated during verification is different from the digest of the CBD calculated during the BURL creation process, the bound reference is rejected at 245.

If it is determined that the digest of the CBD (computed content binding document digest) calculated during verification is the same as the digest of the CBD calculated during the BURL creation process and obtained in operation 200, the CBD is parsed to obtain the individual elements at 220. As discussed herein, the content binding document may include a permalink/logical-link, a fragment-identifier, a content-digest-method, a content-digest, and a content-normalization-method.

Content c from the permalink (subselected by the fragment-identifier) is retrieved at 225. The content c may be retrieved using the permalink (URL) that links to the web page hosted on the server 340.

The content c that has been retrieved is normalized using the content-normalization-method at 230. The content-normalization-method was obtained from the CBD.

During the verification process, a digest H(c) is calculated for the content c using the content-digest-method resulting in a computed content digest at 235. The content-digest-method was obtained from the CBD.

A check is performed to determine whether the digest (computed content digest) calculated for the content during the verification process is the same as the content-digest computed during the BURL creation process (and obtained from the CBD in operation 220) at 240. If it is determined that the computed content digest calculated during the verification process is different from the content-digest calculated during the BURL creation process, the bound reference is rejected at 245.

If it is determined that the computed content digest calculated during the verification process is the same as the content-digested calculated during the BURL creation process, the bound reference is accepted at 250.

In accordance with exemplary embodiments, the ability to reference content at a fine granularity, i.e., to subselect content (within a document retrieved from a URL) is provided by the explicit and full support of fragment identifiers, both in BURL production and in BURL consumption. A URL provides access to a document, while the addition of fragment identifiers to URLs allows access to portions of a document (a word, a paragraph, an image, etc.).

The ability to link old and new versions of content may refer to the following: if content changes according to some predictable schedule (e.g., news headlines, updated Wikipedia articles), it is common practice to assign a fixed logical link (URI) to refer to its latest version, and different permalinks to refer to individual versions (e.g., older news headlines, archived Wikipedia articles). Since each content binding document stores the permalink of the bound content according to exemplary embodiments, the two content versions can be compared for strict equality starting from their BURLs. The procedure consists of using the two BURLs for retrieving two content binding documents, and calculating their digests H(c) as also described in operations 200 through 235. Two versions (an older and a newer version of the same logical content) match, if their two digests H(c) are the same, and if the logical links in the two content binding documents are the same.

Although non-limiting examples described herein are directed to bound URLs, it should be appreciated that the invention is not restricted to bound URLs. Rather, the invention provides a mechanism for creating and verifying any type of bound reference.

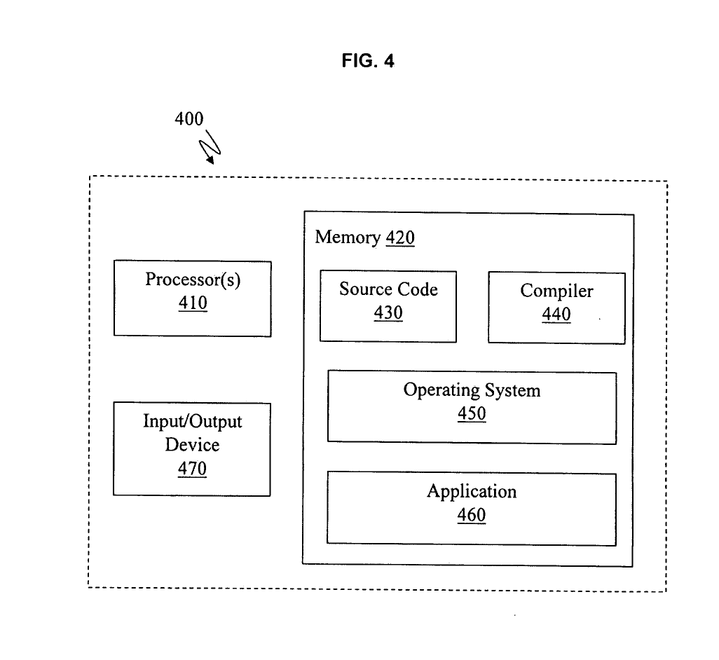

FIG. 4 illustrates an example of a computer 400 having capabilities, which may be included in exemplary embodiments. Various methods, procedures, and techniques discussed herein may also utilize the capabilities of the computer 400. One or more of the capabilities of the computer 400 may be incorporated in any element discussed herein.

Generally, in terms of hardware architecture, the computer 400 may include one or more processors 410, memory 420, and one or more input and/or output (I/O) devices 470 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 410 is a hardware device for executing software that can be stored in the memory 420. The processor 410 can be virtually any custom made or commercially available processor, a central processing unit (CPU), a data signal processor (DSP), or an auxiliary processor among several processors associated with the computer 400, and the processor 410 may be a semiconductor based microprocessor (in the form of a microchip) or a macroprocessor.

The memory 420 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 420 may incorporate electronic, magnetic, optical, and/or other types of storage media. Note that the memory 420 can have a distributed architecture, where various components are situated remote from one another, but can be accessed by the processor 410.

The software in the memory 420 may include one or more separate programs, each of which comprises an ordered listing of executable instructions for implementing logical functions. The software in the memory 420 includes a suitable operating system (O/S) 450, compiler 440, source code 430, and an application 460 (which may be one or more applications) of the exemplary embodiments. As illustrated, the application 460 comprises numerous functional components for implementing the features and operations of the exemplary embodiments. The application 460 of the computer 400 may represent various applications, agents, software components, etc., but the application 460 is not meant to be a limitation.

The operating system 450 may control the execution of other computer programs, and provides scheduling, input-output control, file and data management, memory management, and communication control and related services.

The application 460 may be a source program, executable program (object code), script, or any other entity comprising a set of instructions to be performed. When a source program, then the program is usually translated via a compiler (such as the compiler 440), assembler, interpreter, or the like, which may or may not be included within the memory 420, so as to operate properly in connection with the O/S 450. Furthermore, the application 460 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, NET, and the like.

The I/O devices 470 may include input devices such as, for example but not limited to, a mouse, keyboard, scanner, microphone, camera, etc. Furthermore, the I/O devices 470 may also include output devices, for example but not limited to, a printer, display, etc. Finally, the I/O devices 470 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 470 also include components for communicating over various networks, such as the Internet or an intranet.

When the computer 400 is in operation, the processor 410 is configured to execute software stored within the memory 420, to communicate data to and from the memory 420, and to generally control operations of the computer 400 pursuant to the software. The application 460 and the O/S 450 are read, in whole or in part, by the processor 410, perhaps buffered within the processor 410, and then executed.

When the application 460 is implemented in software it should be noted that the application 460 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 460 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 460 is implemented in hardware, the application 460 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is understood that the computer 400 includes non-limiting examples of software and hardware components that may be included in various devices and systems discussed herein, and it is understood that additional software and hardware components may be included in the various devices and systems discussed in exemplary embodiments.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for referencing content by generating a bound uniform resource locator, comprising:
selecting content;
calculating a fragment identifier for the content;
normalizing the content;
calculating a content digest of the normalized content;
assembling a content binding document, wherein the content binding document comprises:
an original URL to the content;
the fragment identifier;
a name of a method for normalizing the content;
a name of a method for calculating the content digest; and
the content digest;
calculating a content binding document digest;
generating a bound universal resource locator that contains the content binding document digest and the name of the method used to calculate the content binding document digest; and
storing the content binding document, wherein the content binding document can be retrieved using the bound universal resource locator.

2. The method of claim 1, wherein selecting content comprises selecting media.

3. The method of claim 1, wherein selecting the content comprises retrieving the content from the original URL.

4. The method of claim 1, wherein the fragment identifier is a pointer within the content; and
wherein the fragment identifier is an XPointer expression.

5. The method of claim 1, wherein the content is hosted on a server; and
wherein the content binding document is hosted on a different server.

6. The method of claim 1, wherein the bound uniform resource locator comprises the content binding document digest and a location of the content binding document.

7. The method of claim 1, wherein the content binding document is an XML document.

8. The method of claim 1, wherein the bound uniform resource locator comprises resources to confirm or deny a validity of the content.

9. A method for verifying content that has been referenced by a bound uniform resource locator, comprising:
parsing a bound uniform resource locator to obtain a content binding document digest and to obtain a method for calculating the content binding document digest;
retrieving a content binding document using the bound uniform resource locator;
calculating a computed content binding document digest using the method for calculating the content binding document digest obtained from the bound uniform resource locator;
comparing the computed content binding document digest to the content binding document digest;
in response to the computed content binding document digest being the same as the content binding document digest, parsing the content binding document to obtain individual elements, wherein the content binding document comprises:
an original URL to a content;
a fragment identifier;
a name of a method for normalizing the content;
a name of a method for calculating a content digest; and
the content digest;
retrieving the content using the original URL to the content;
normalizing the content using the method for normalizing the content obtained from the content binding document;
calculating a computed content digest using the method for calculating the content digest obtained from the content binding document;
comparing the computed content digest to the content digest; and
in response to the computed content digest being the same as the content digest, accepting the validity of the bound URL.

10. The method of claim 9, wherein the bound URL provides a location to a server.

11. The method of claim 9, wherein the computed content binding document digest is calculated at a different time from the content binding document digest.

12. The method of claim 9, further comprising in response to the computed content binding document digest being different from the content binding document digest, rejecting the bound URL.

13. The method of claim 9, further comprising in response to the computed content digest being different from the content digest, rejecting the bound URL.

14. The method of claim 9, wherein the content binding document is an XML document.

15. The method of claim 9, wherein the content is hosted on a server; and
wherein the content binding document is hosted on a different server.

16. A computer program product, tangibly embodied on a computer readable medium, for referencing content by generating a bound uniform resource locator, the computer program product including instructions for causing a computer to execute a method, comprising:
selecting content;
calculating a fragment identifier for the content;
normalizing the content;
calculating a content digest of the normalized content;
assembling a content binding document, wherein the content binding document comprises:
an original URL to the content;
the fragment identifier;
a name of a method for normalizing the content;
a name of a method for calculating the content digest; and
the content digest;
calculating a content binding document digest;
generating a bound universal resource locator that contains the content binding document digest and the name of the method used to calculate the content binding document digest; and
storing the content binding document, wherein the content binding document can be retrieved using the bound universal resource locator.

17. The computer program product of claim 16, wherein selecting content comprises selecting media.

18. The computer program product of claim 16, wherein selecting the content comprises retrieving the content from the original URL.

19. The computer program product of claim 16, wherein the fragment identifier is a pointer within the content; and
wherein the fragment identifier is an XPointer expression.

20. The computer program product of claim 16, wherein the content is hosted on a server; and
wherein the content binding document is hosted on a different server.
